(19) United States
(12) Patent Application Publication
(10) Pub. No.: US 2010/0217410 A1
(43) Pub. Date: Aug. 26, 2010

(54) USER INTERFACE FOR HOME MEDIA SYSTEM

(76) Inventor: Yang Pan, (US)

Correspondence Address: Yang Pan;Intellectual Power Pte Ltd, No. 14 Robinson Road #06-01,, Far East Finance Building, Singapore, 048545, SG

(21) Appl. No.: 12/390,493

(22) Filed: Feb. 22, 2009

(51) Int. Cl. G06F 17/00; G06F 3/048; G06F 17/30

(52) U.S. Cl. 700/94; 715/716; 707/E17.009; 707/E17.102; 707/E17.044

(57) ABSTRACT

An improved user interface for a home media delivery system is disclosed. The system comprises a media delivery unit, a removable media storage unit and a remote control device. In one embodiment, the media delivery system is a home audio system and the removable media storage unit is an optical disk. The invention is characterized by that metadata of the media assets stored in the removable storage unit is read out by the delivery unit after media storage unit is connected to the delivery unit. The metadata is transmitted wirelessly to the remote control device and is displayed on its display in a user selectable form. The user's selection is then transmitted to the delivery unit for directing the operation of the playback. The invention is further characterized by that the metadata may take a hierarchical form for at least two levels. The first level of data including basic information as authors, artists and genres is displayed at the first step and the second level of data including a more detailed description of the selected media asset is displayed after the user's selection.

### CROSS-REFERENCE TO RELATED APPLICATIONS

Not applicable.

### BACKGROUND

1. Field of Invention

This invention relates to a media delivery system, specifically to an improved user interface for a home media system.

2. Description of Prior Art

Despite of the gained popularity of handheld media players, significant amount of media assets are still being delivered to users through conventional home electronic appliances such as through a home audio system (high-fidelity audio system). A conventional home audio system includes an optical disk player, a signal processor and speakers. The media assets are stored in a removable storage unit such as in an optical disk as “tracks” in a sequential manner. The operation of the home audio system is controlled by a user through a remote control device. A remote control device for a home audio system with numeric keys provides a means for the user to select a media asset for playback in the home audio system.

A user often needs to refer back to TOC (Table-Of-Contents) of the assets for the selection, which is typically printed on the back surface of a case for the optical disk. It is desirable that the TOC is displayed on a screen of the remote control device. The user can then select the media asset with greater easiness. It is further desired that more information about a selected media asset can be accessed by the user by employing the same display screen.

Therefore, it is an objective of the present invention to improve the home audio system with a removable storage unit to have a user friendly interface that displays user selectable media items on the display screen of the remote control device.

It is another objective of the present invention to provide a user interface that more information about a specific media asset is displayed after the asset is selected.

### SUMMARY OF THE INVENTION

Home audio system is used as an exemplary illustration of the present inventive concept. A home audio system comprises an audio delivery unit, an optical disk and a remote control device. The optical disk includes multiple areas for storing different types of data. It is arranged sequentially with a lead in area, a program area including multiple tracks and a lead out area. In the lead in area, TOC data is stored in accordance with optical disk standards. In one implementation, data stored in the TOC area is taken as the metadata of audio assets. In another implementation, a specific storage sub-area for metadata is inserted in between the sub-area for lead in data and the sub-area for the TOC data. For such an implementation, the metadata may have a two-level hierarchy. The first level includes the titles, authors and genres of the media assets and the second level may include further description of the media asset.

The present invention is characterized by that the metadata is read out by the audio delivery unit after the optical disk is loaded up to the system. The metadata is then transmitted wirelessly to the remote control device through an ad hoc wireless communication link established between the two devices. After receiving the metadata by an integrated transceiver of the remote control device, the processor of the device displays the metadata on the screen. After reviewing the displayed data, the user may select a specific asset for playback and the processor of the remote control device controls an operation to transmit the user's selection to the audio delivery unit. The processor of the audio delivery unit then executes an operation of playback based upon the received user selection by its wireless transceiver.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of a media delivery system comprising a media delivery unit, a removable media storage unit and a remote control device.

FIG. 2a is a schematic representation of storage areas of an optical disk.

FIG. 2b is a schematic representation of storage areas of an optical disk with an added sub-area for metadata.

FIG. 3 shows a flow diagram of the operation of the improved user interface of the home media system.

FIG. 4 shows a flow diagram of the operation of the improved user interface of the home media system with a two-level of hierarchy of metadata according to one implementation.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

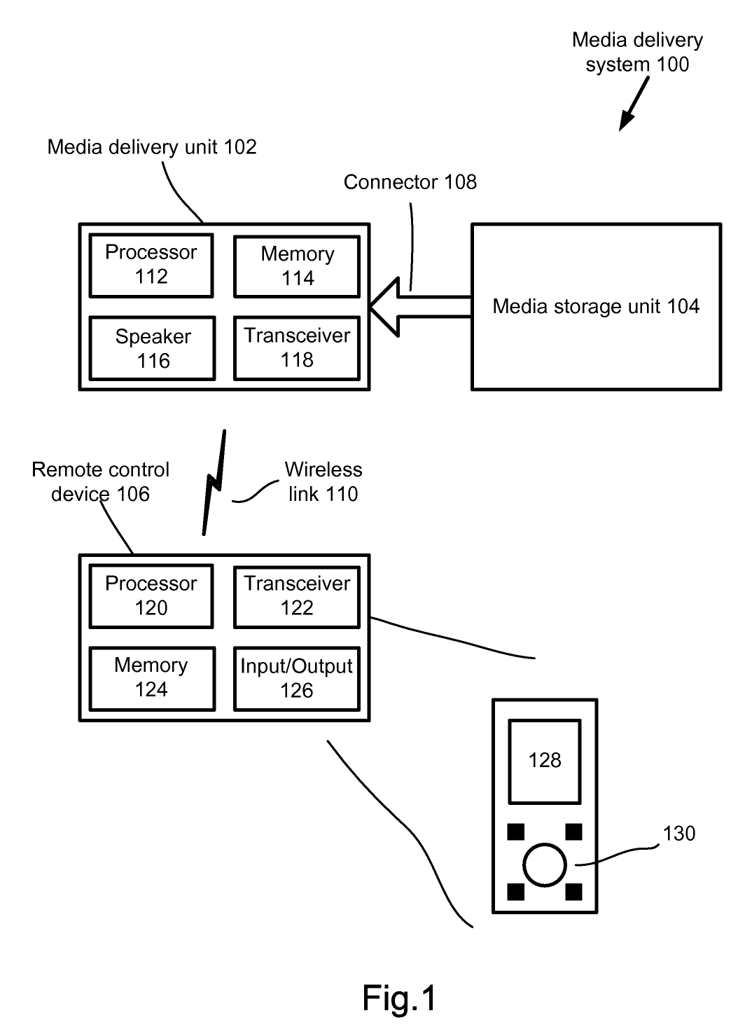

FIG. 1 shows a schematic diagram of a media delivery system based upon the present invention. The system 100 includes a media delivery unit 102, a removable media storage unit 104 and a remote control device 106. The media delivery unit 102 and the media storage unit 104 are connectable through a connector 108. The media delivery unit 102 and the remote control device 106 are connectable through wireless link 110.

A home audio delivery unit is taken as exemplary illustration of the media delivery unit 102. The unit 102 further comprises a processor 112, a memory 114, a speaker 116 and a transceiver 118. The processor 112 is a microprocessor or microcontroller that pertains to control the operation of the media delivery unit. The processor 112 may also include a CODEC (coder/decoder) for audio signal processing. The memory 114 may be a semiconductor memory device such as a flash memory device or a plurality of flash memory devices. It may also be a hard disk driver. The transceiver 118 may be a wireless communication device conforming to various wireless communication standards such as for example, Bluetooth (IEEE 802.11b) or ZigBee (IEEE 802.15.4). In another implementation, the transceiver 118 may be replaced by an optical communication interface such as a device providing the communication link by the use of the infrared light or the visible light.

The inventive concept can be extended to a home video delivery system for one skillful in the art. A television terminal will need to be added to the media delivery unit.

In one implementation for the home audio system, the removable media storage unit 104 is an optical disk. The optical disk may be connected to the media delivery unit through an optical disk loader. The data stored in the disk is read out through an optical means as known in the art.

In another implementation, the media storage unit 104 includes a semiconductor memory such as a flash memory device or a plurality of flash memory devices. The semiconductor memory device may be connected to the media delivery unit through a FIREWIRE (IEEE 1394) type of connection or through a USB (Universal Serial Bus) type of connection. In yet another implementation, the removable media storage unit may be a magnetic storage device such as a hard disk and the data is read out by a magnetic means as know in the art.

The remote control device 106 comprises a processor 120, a transceiver 122, a memory 124 and an input/output unit 126. The input/output unit further includes a display screen 128 and a user input device 130. The remote control device 106 is powered by a battery (not shown in the figure). The processor 120 is a microprocessor or microcontroller that pertains to control the operation of the remote control device 106. The transceiver 122 may be a wireless communication device conforming to various wireless communication standards such as for example, Bluetooth (IEEE 802.11b) or ZigBee (IEEE 802.15.4). In another implementation, the transceiver 122 may be replaced by an optical communication device by the use of the infrared light or the visible light. The memory 124 may be a semiconductor memory device such as a flash memory device or a plurality of flash memory devices. The display screen 128 may be a LCD (Liquid Crystal Display). It may also be a touch-screen type of display. In such an implementation, the user may control the operation of the device by use his or her fingers or a stylus. The user input device 130 may include a rotational user interface and various buttons, keys and touch-pads.

A home audio system with the optical disk as the storage unit is employed as an exemplary case in the following description to illustrate the present inventive concept.

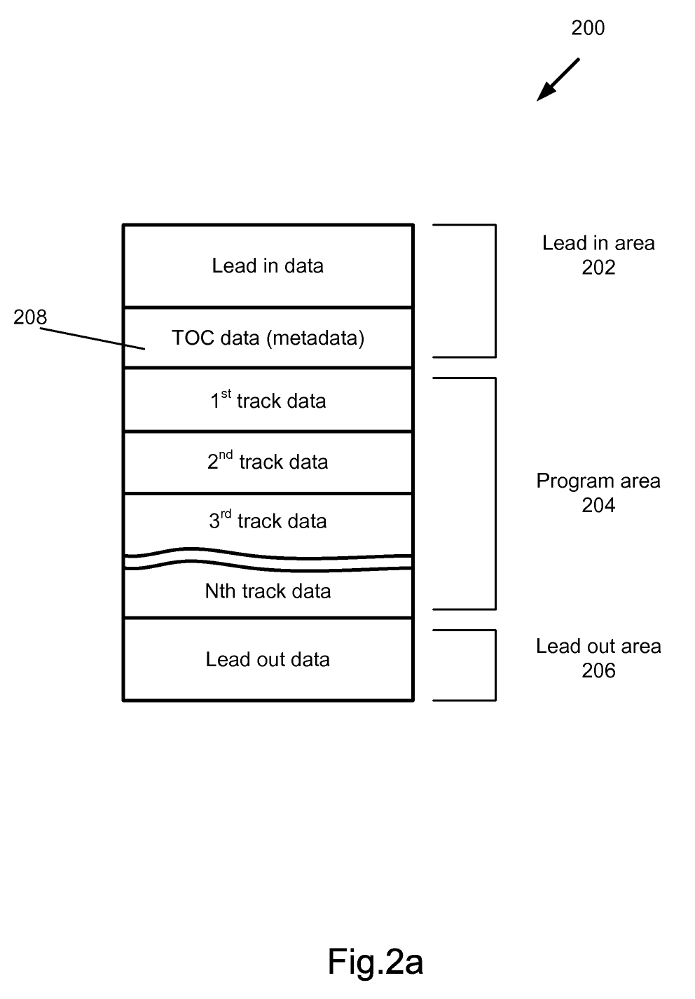

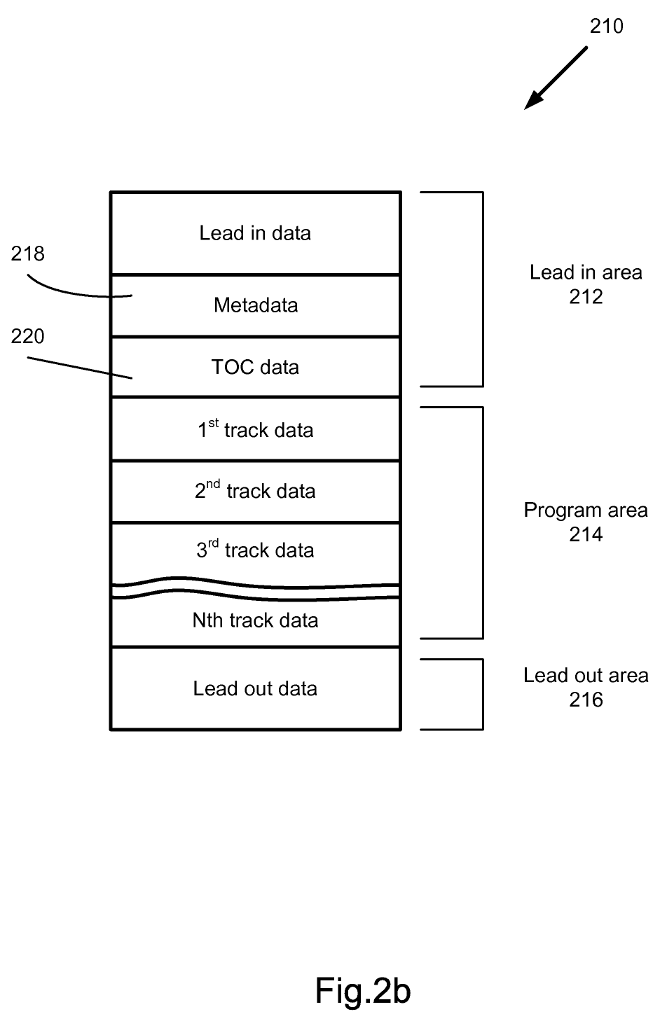

FIG. 2a is a schematic representation of the storage area of an optical disk. The optical disk is divided into multiple areas for storing different type of data. The data are stored in a sequentially manner as shown in the figure. The storage media 200 starts with a lead in area 202 and the area 202 is followed by a program area 204 and then a lead out area 206. The lead in area 202 further includes a sub-area 208 for storing TOC of the assets stored in the disk. In one implementation, TOC data may be taken as the metadata of the stored assets. The metadata (TOC) may only include basic data about a media asset such as author, artist and genres.

The program area 204 includes multiple tracks arranged in a sequential manner. Each track is used to store one media asset.

FIG. 2b is a schematic representation of another implementation of the optical disk including a dedicated sub-area for the metadata. An advantage of such an implementation is that more information in a hierarchical manner may be included. As shown in the figure, the optical disk 210 is divided into multiple areas for storing different type of data. The optical disk 210 starts with a lead in area 212 and the area 212 is followed by a program area 214 and then a lead out area 216. The lead in area 212 further includes a sub-area 218 for storing the metadata and another sub-area 220 for storing TOC. A convention optical disk would only have the TOC sub-area following the lead in data as shown in FIG. 2a.

The metadata may only contain basic data about a media asset such as author, artist and genres. The metadata may also take a hierarchical form including at least two levels. The first level may still include basic data as described. The second level may include a more detailed description of the asset such as, for example, content of a song. The second level data will only be displayed if the specific media asset is selected by the user.

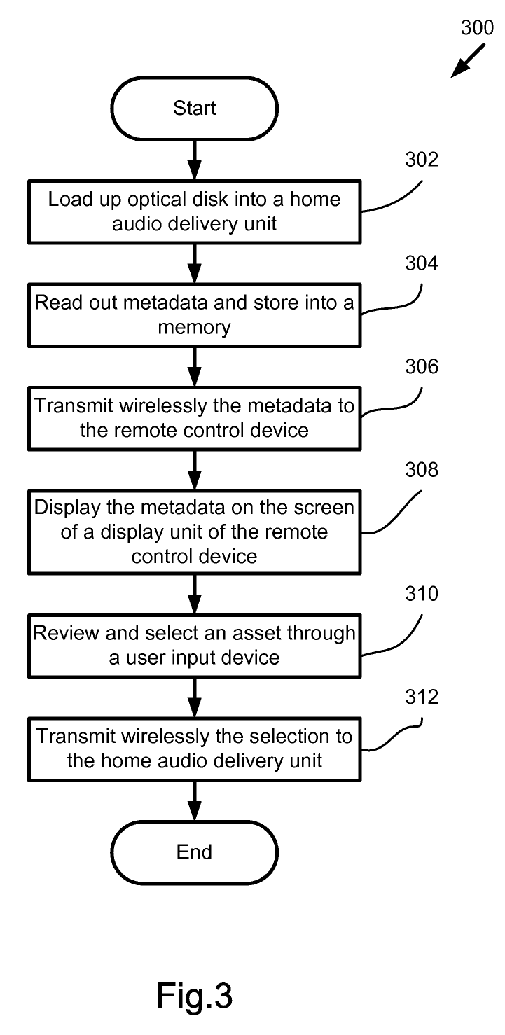

FIG. 3 shows a flow diagram of a process 300 illustrating the operation of the improved user interface of the home audio delivery system 100. The process 300 describes a method that the metadata is read out from an optical disk 104 by the home audio delivery unit 102 and is then transmitted wirelessly to the remote control device 106 and be displayed on its display screen 128. The process 300 starts with step 302 that the optical disk 104 is loaded into a home audio delivery unit 102. The metadata is then read out from the disk 104 controlled by the processor 112 to the memory 114 of the audio delivery unit 102 in step 304. The metadata is then transmitted by the transceiver 118 through the wireless link 110 to the transceiver 122 of the remote control device 106 in step 306. The received data is stored in the memory 124. In step 308, the received metadata is displayed on the screen 128 of the remote control device 106. The user reviews and then selects a media asset through the user input device 130 of the remote control device 106 in step 310. The user's selection is transmitted wirelessly through the transceiver 122 to the home audio delivery unit 102 in step 312. The transmission is controlled by the processor 120 of the remote control device 106.

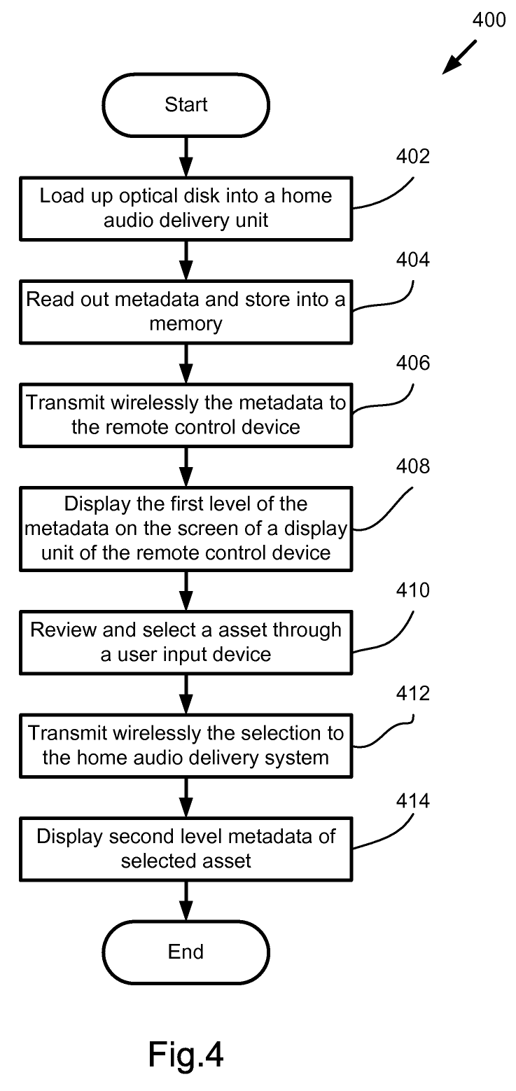

The metadata may take a hierarchical form including at least two levels. FIG. 4 shows a flow diagram of a process 400 of the improved user interface of the home audio delivery system 100 with two level of metadata according to one implementation. The process 400 starts with step 402 that the optical disk 104 is loaded into a home audio delivery unit 102. The metadata is then read out from the disk 104 to the memory 114 of the audio delivery unit 102 in step 404. The metadata is transmitted by the use of the transceiver 118 through the wireless link 110 to the remote control device 106 in step 406. In step 408, the first level metadata is displayed on the screen 128 of the remote control device 106. The user reviews and the selects a media asset through the user input device 130 in step 410. The user's selection is then transmitted wirelessly through the transceiver 122 under the control of the processor 120 to the home audio delivery unit 102 in step 412. The second level metadata including more detailed description of the selected media asset is displayed on the screen 128 in step 414.

All data stored in the memory 114 of the audio delivery unit 102 and in the memory 124 of the remote control device 106 may be erased after the optical disk 104 is removed from the audio delivery unit 102.

While the invention has been disclosed with respect to a limited number of embodiments, numerous modifications and variations will be appreciated by those skilled in the art. The audio assets have been used as the exemplary cases in the disclosure. The invention concept can be extended to video or multi-media files for one skillful in the art. The home audio system has been used to illustrate the inventive concept. It, however, can be extended to other media delivery units suck as car media systems. It is intended that all such variations and modifications fall within the scope of the following claims:

1. A method of selecting one media asset from a plurality of media assets stored in a removable media storage unit for playback in a media delivery unit by a remote control device, the method comprising:
a) connecting the media storage unit to the media delivery unit;
b) reading out metadata of the stored media assets by the media delivery unit;
c) transmitting the metadata wirelessly to the remote control device;
d) displaying metadata of media assets in a display unit of the remote control device;
e) selecting one media asset for playback through a user input unit of the remote control device; and;
f) transmitting wirelessly the data associated with the selection to the media delivery unit.

2. The method as recited in claim 1, wherein the removable media storage unit is an optical disk including a plurality of areas for storing different types of data.

3. The method as recited in claim 2, wherein said optical disk comprising at least one area for storing the metadata of the stored media assets.

4. The method as recited in claim 3, wherein said area for storing the metadata is arranged before the area for storing the media assets in a sequential manner.

5. The method as recited in claim 1, wherein the media delivery unit is a home audio system and the media assets are audio files.

6. The method as recited in claim 1, wherein the media delivery unit is a home video delivery system and the media assets are video/audio files.

7. A system for delivering a media asset to a user, the system comprising:
a) a media delivery unit for delivering the media asset to the user;
b) a remote control device including a display for controlling operation of the media delivery unit; and
c) a removable media storage unit for storing a plurality of media assets,
wherein the system is characterized by providing a means for the user to select through the display of the remote control device a media asset for playback based upon received metadata of a plurality of media assets transmitted wirelessly from the media delivery unit.

8. The system as recited in claim 7, wherein said metadata is stored in the removable media storage unit and is read out by the media delivery unit after the storage unit is connected to the delivery unit.

9. The system as recited in claim 7, wherein the removable media storage unit is an optical disk including a plurality of areas for storing different types of data.

10. The system as recited in claim 9, wherein said optical disk comprising at least one area for storing the metadata of the stored media assets.

11. The system as recited in claim 10, wherein said area for storing the metadata is arranged before the area for storing the media assets in a sequential manner.

12. The system as recited in claim 7, wherein the removable media storage unit comprising a semiconductor memory.

13. The system as recited in claim 7, wherein the removable media storage unit comprising a magnetic storage device.

14. The system as recited in claim 7, wherein the media delivery unit is a home audio system and the media assets are audio files.

15. The system as recited in claim 7, wherein the media delivery unit is a home video system and the media assets are video/audio files.

16. The system as recited in claim 7, wherein the media delivery unit and the remote control device are connected wirelessly through an optical link or an ad-hoc wireless connection including a Bluetooth type of connection (IEEE 802.11b) and a ZigBee (IEEE 802.15.4) type of connection.

17. A method for generating a list of user selectable media assets on a display of a remote control device, the method comprising:
a) receiving by the remote control device metadata of the media assets transmitted from the media delivery unit through a wireless communication means;
b) displaying a first level of metadata for the user selectable media assets sequentially on the display; and
c) displaying a second level of metadata for a selected item after a user's selection.

18. The method as recited in claims 17, wherein the first level of the metadata including title, artist and genres associated with a media asset.

19. The method as recited in claim 17, wherein the second level of metadata including more detailed description of a media asset in addition to the first level of the metadata.

20. The method as recited in claim 17, wherein the metadata of a plurality of media assets is stored in a separate area of the removable media storage unit from the areas for storing the media assets and is read out by the media delivery unit immediately after the removable media storage unit is connected to the media delivery unit.
